(19) United States
(12) Patent Application Publication
(10) Pub. No.: US 2026/0269359 A1
(43) Pub. Date: Sep. 10, 2026

(54) MULTILAYER STRUCTURE, SOLID-STATE BATTERY, METHODS FOR MANUFACTURE AND HEATING

(71) Applicants: FastLion Energy Inc., State College, PA (US); Ampcera Inc., Tucson, AZ (US)

(72) Inventors: James Emery Brown, Tucson, AZ (US); Eric Scott Rountree, Alexandria, PA (US); Hui Du, Tucson, AZ (US); Eongyu Yi, Tucson, AZ (US)

(21) Appl. No.: 19/327,388

(22) Filed: Sep. 12, 2025

Related U.S. Application Data
(60) Provisional application No. 63/768,373, filed on Mar. 7, 2025.

(51) Int. Cl. H01M 10/654; H01M 10/42; H01M 10/615; H01M 10/63; H01M 10/6571; H01M 50/46; H01M 50/474; H01M 50/483

(52) U.S. Cl. CPC H01M 10/654; H01M 10/425; H01M 10/615; H01M 10/63; H01M 10/6571; H01M 50/46; H01M 50/474; H01M 50/483; H01M 2010/4271

(57) ABSTRACT

A multilayer structure includes: a conductive heating layer configured to generate heat through resistive heating when an electrical current is applied; and a first rigid dielectric composite layer positioned on a first side of the conductive heating layer and a second rigid dielectric composite layer positioned on a second side of the conductive heating layer, wherein the first and second rigid dielectric composite layers are electrically insulating and have a Young's modulus greater than 1 GPa.

### PRIORITY

This application claims the benefit of U.S. Provisional Patent Application No. 63/768,373, filed Mar. 7, 2025, the entire contents of which are hereby incorporated by reference herein.

### GOVERNMENT RIGHTS

This invention was made with Government support under DE-AR0001731 awarded by Advanced Research Projects Agency—Energy (ARPA—E). The government has certain rights in the invention.

### FIELD

The present application relates to solid-state batteries, and more particularly, to a multilayer structure within a solid-state battery stack that integrates a conductive heating layer and rigid dielectric composite layers. The application also relates to solid-state battery configurations incorporating the multilayer structure, as well as methods for manufacturing and heating such batteries.

### BACKGROUND

Solid-state batteries have gained attention as an alternative to conventional lithium-ion batteries owing to their potential for increased energy density, improved safety, and longer cycle life. Unlike liquid-based electrolytes, solid electrolytes provide enhanced thermal and chemical stability, reducing risks associated with leakage and thermal runaway. However, solid-state electrolytes often exhibit lower ionic conductivity, particularly at lower temperatures, which can lead to increased internal resistance and reduced charge-discharge efficiency.

Various approaches have been explored to improve the performance of solid-state batteries, including the incorporation of heating elements to elevate the solid electrolyte temperatures and enhance ionic mobility. These heating elements may be external to the battery or embedded within the battery stack itself. When integrated within the stack, heating elements must be mechanically and electrically compatible with surrounding battery layers to maintain efficient operation.

In addition to thermal considerations, solid-state battery stacks are subject to mechanical forces during manufacturing and operation. The materials and structures within the stack must accommodate these forces to prevent degradation over time. Different insulating and structural materials have been used to manage pressure distribution and maintain battery integrity, including polymeric films and elastomeric materials. These materials vary in their ability to provide electrical insulation, mechanical support, and resistance to deformation over repeated thermal cycling and compression.

As solid-state battery technology continues to develop, improvements in thermal regulation and mechanical stability remain areas of focus. The integration of heating elements, the selection of insulating and structural materials, and the design of multilayer configurations within the battery stack are among the factors influencing overall battery performance and reliability.

### SUMMARY

The present description relates to a multilayer structure designed for integration into a solid-state battery to enhance thermal management and mechanical stability. This multilayer structure comprises a conductive heating layer that generates heat through resistive heating when an electrical current is applied. Positioned on opposite sides of this heating layer are rigid dielectric composite layers that are electrically insulating and have a Young's modulus greater than 1 GPa to ensure mechanical reinforcement and prevent deformation.

A battery incorporating this multilayer structure comprises multiple electrochemical cells, where each cell includes a first electrode, a second electrode, and an electrolyte positioned between them. Current collectors are associated with the electrochemical cells, facilitating charge transfer. The multilayer structure is positioned between these current collectors, with the conductive heating layer selectively generating heat to regulate the electrolyte's temperature, improving ionic conductivity. The heating layer remains electrically isolated from the current collectors, ensuring efficient operation without electrical interference.

The invention also includes methods for manufacturing the multilayer structure and the battery incorporating it. The multilayer structure is produced by forming two rigid dielectric composite layers, each with a Young's modulus greater than 1 GPa, and positioning a conductive heating layer between them. Alternatively, the multilayer structure is produced by forming two rigid dielectric composite layers, each with a Young's modulus greater than 1 GPa, onto opposite sides of the conductive heating layer. These layers are bonded together to create a stable unit. The battery manufacturing process can involve pre-fabricating the multilayer structure separately and inserting it into the battery stack or directly forming the rigid dielectric composite layers onto the current collectors before adding the conductive heating layer.

A method for heating the multilayer structure involves applying an electrical current to the conductive heating layer, which generates heat through resistive heating. This heat is transferred to the surrounding battery components to maintain optimal temperature conditions. Similarly, a method for heating a battery involves activating the conductive heating layer within the multilayer structure, allowing controlled heat transfer to the electrolyte, enhancing ionic conductivity, and ensuring efficient battery performance in various environmental conditions.

Other embodiments of the disclosure will become apparent from the following detailed description, the accompanying drawings and the appended claims.

### BRIEF DESCRIPTION OF THE DRAWINGS

FIG. 1 is a cross-sectional schematic of a solid-state battery stack incorporating a multilayer structure for thermal regulation and mechanical stability, showing the arrangement of electrodes, current collectors, and the multilayer structure positioned between rigid dielectric composite layers.

FIG. 2 is an exploded schematic view of a portion of a solid-state battery stack, showing the multilayer structure positioned between adjacent current collectors, each having an associated tab, with the anodes, cathodes, and solid-state electrolyte separators omitted for clarity.

FIG. 3 includes photographic images showing the imprinting effect of a patterned heating element when incorporated without reinforcement. The left-hand image shows a heater pattern transferred onto a copper current collector foil, and the right-hand image shows a heater pattern appearing on the surface of a pouch cell.

### DETAILED DESCRIPTION

The present description provides an improved multilayer structure for solid-state battery stacks, comprised of a conductive heating layer, typically a patterned conductive heating layer, positioned between two rigid dielectric composite layers. The heating layer generates heat through resistive heating, enabling thermal regulation of the solid-state electrolyte to enhance ionic conductivity and overall battery performance. The rigid dielectric composite layers, located on opposite sides of the heating layer, serve as electrically insulating structural components that provide uniform pressure distribution and prevent pattern imprinting from the heating layer. In the case of the patterned conductive heating layer, the void spaces in the pattern may be filled with rigid dielectric.

Each rigid dielectric composite layer is composed of a non-electrically conductive material with a Young's modulus greater than 1 GPa, ensuring sufficient mechanical stiffness to mitigate localized stress concentrations. By preventing mechanical deformation and pressure inconsistencies, these layers contribute to the overall stability and longevity of the battery stack.

The multilayer structure is designed to be integrated within a solid-state battery, positioned between the current collectors to improve both mechanical stability and thermal management. This configuration allows for efficient heating without compromising electrochemical performance, making it particularly advantageous in applications requiring fast charging, high-power discharge, and stable operation under varying environmental conditions. By improving pressure distribution and thermal regulation within the battery stack, the present disclosure enhances battery reliability, manufacturability, and long-term durability.

### The Multilayer Structure

The multilayer structure is a stacked configuration of a conductive heating layer positioned between two rigid dielectric composite layers, forming a mechanically stable and thermally regulated unit within a solid-state battery stack. This structure improves pressure distribution, prevents pattern imprinting, and provides controlled heating of the battery's solid electrolyte, enhancing ionic conductivity and overall battery performance.

The conductive heating layer, centrally positioned within the multilayer structure, generates heat through resistive heating when an electrical current is applied. It typically takes the form of a foil, but may also include other configurations. The heating layer can be continuous or include gaps, interruptions, or patterned resistance paths to regulate electrical flow.

The rigid dielectric composite layers, positioned on opposite sides of the heating layer, provide mechanical support, electrical insulation, and pressure distribution. These layers prevent mechanical inconsistencies from propagating into adjacent battery layers, ensuring uniform compression during assembly and operation. Their rigidity, defined by a Young's modulus greater than 1 GPa ensures resistance to deformation while allowing for controlled thermal expansion within the battery stack.

The multilayer structure may further include additional layers, depending on the specific design and operational requirements of the solid-state battery stack. These additional layers can enhance mechanical stability, thermal regulation, electrical insulation, and integration with other battery components. Adhesive layers may be incorporated between the conductive heating layer and the rigid dielectric composite layers to improve mechanical integrity and ensure stable bonding. Barrier layers can be introduced to protect the conductive heating layer from oxidation, moisture ingress, or chemical interactions with adjacent battery components. Encapsulation layers may surround the entire multilayer structure to provide additional mechanical protection and ensure long-term reliability. The integration of additional layers into the multilayer structure can be adjusted based on the needs of the battery system. In some embodiments, the multilayer structure consists solely of the conductive heating layer and the rigid dielectric composite layers, while in others, supplementary layers provide enhanced performance characteristics.

### Conductive Heating Layer

The conductive heating layer is a central component of the multilayer structure, providing localized thermal regulation within the solid-state battery stack. Positioned between two rigid dielectric composite layers, the heating layer generates heat through resistive heating when an electrical current is applied, raising the internal temperature of the solid-state electrolyte to improve ionic conductivity and overall battery efficiency.

The heating layer may be composed of a variety of electrically conductive materials, including metal foils such as aluminum, nickel, copper, or stainless steel, as well as conductive films, pastes, or printed traces made from carbon-based or metal-oxide materials. The material selection depends on factors such as electrical resistance, thermal conductivity, mechanical durability, and compatibility with adjacent layers. Thin-film resistive coatings and conductive inks, including those based on silver, graphene, or carbon nanotubes, may also be utilized to create heating elements with precise resistance characteristics.

The geometry of the heating layer can vary depending on the thermal management strategy of the battery. The layer may be a continuous film that provides uniform heating across the interface, or a patterned structure with controlled resistance paths that generate localized heating in designated regions. The heating pattern can take the form of serpentine traces, interdigitated electrodes, grid structures, or segmented heating zones, allowing for tunable heat distribution based on battery design requirements. Gaps or interruptions in the conductive layer can be introduced to control current flow and optimize heating efficiency, ensuring that thermal energy is delivered where needed without creating excessive localized hotspots.

The heating layer may be self-supported as a foil or deposited onto a substrate, such as a thin ceramic or polymeric support layer, to enhance mechanical integrity and ease of integration within the battery stack. In cases where printed heating elements are used, the conductive layer can be applied to a flexible or rigid substrate using techniques such as screen printing, sputtering, vacuum deposition, or inkjet printing.

Electrical connections to the heating layer are made through electrodes that facilitate current flow across the resistive structure. These electrodes may be positioned at opposing edges of the heating layer, enabling a uniform distribution of electrical current, or they may be arranged in a distributed configuration to create independently controlled heating zones. Electrode materials are selected for their high conductivity and durability, with common options including silver, nickel, copper, and conductive polymer films. The electrodes may be integrated into the heating layer via deposition, plating, or printed circuitry, ensuring minimal electrical resistance and reliable performance over extended operational cycles. The electrodes may also be referred to as tabs or terminals that extend past the solid-state battery casing. Note that these tabs or terminals are a secondary set to the tabs or terminals that are used in the charging and discharging of the solid-state battery.

The integration of the conductive heating layer within the multilayer structure is designed to ensure thermal efficiency, mechanical stability, and electrical insulation. The rigid dielectric composite layers positioned on either side of the heating layer help distribute pressure evenly, preventing mechanical deformation that could affect electrical conductivity or heating performance. These layers also serve as electrical insulators, preventing unintended current leakage while ensuring that generated heat is effectively transferred toward the electrolyte interface.

The conductive heating layer is designed to operate across a range of power levels, depending on the battery's requirements for fast charging, cold-weather operation, or high-power discharge scenarios. Heating power can be actively regulated based on temperature feedback or external control mechanisms, ensuring that the electrolyte remains within an optimal temperature range without excessive energy consumption.

By integrating the heating layer within the multilayer structure, the present description provides a scalable and efficient thermal management solution for solid-state battery stacks. The adaptability of the heating layer's materials, geometry, and configuration allows for customized implementations in different battery architectures, ensuring optimal performance across various applications, including electric vehicles, aerospace, and grid energy storage systems.

### Rigid Dielectric Composite Layers

The rigid dielectric composite layers are positioned on opposite sides of the conductive heating layer, forming a mechanically stable and electrically insulating structure within the solid-state battery stack. These layers ensure uniform pressure distribution, prevent mechanical inconsistencies, and facilitate efficient thermal regulation without interfering with electrochemical performance. By mitigating stress concentrations and maintaining mechanical integrity, the rigid dielectric composite layers contribute to the long-term durability of the battery.

Each rigid dielectric composite layer is composed of a non-electrically conductive material with a Young's modulus greater than 1 GPa, preferably greater than 10 GPa, providing sufficient rigidity to resist deformation while accommodating the mechanical and thermal demands of the battery stack. In some embodiments, the modulus may range from 10 GPa to 50 GPa, which allows for a degree of flexibility while maintaining structural reinforcement. In other implementations, the modulus may be higher, from 50 GPa to 200 GPa, for applications requiring increased resistance to deformation under compressive forces. For configurations that prioritize maximum mechanical stability, materials with a modulus exceeding 200 GPa, including fully dense ceramics, may be used to further enhance structural integrity.

The material composition of the rigid dielectric composite layers may include ceramic-based materials, polymer-ceramic composites, glass-ceramic formulations, aerogels, or other high-modulus insulative materials. Ceramic-based materials, such as alumina (Al₂O₃), zirconia (ZrO₂), silicon carbide (SiC), boron nitride (BN), hafnia (HfO₂), and yttria-stabilized zirconia (YSZ), offer excellent electrical insulation, high thermal stability, and superior mechanical rigidity. These materials provide high compressive strength and resistance to mechanical degradation, making them suitable for applications requiring precise pressure distribution. Polymer-ceramic composites, which incorporate ceramic fillers within a polymeric binder, provide a balance between mechanical rigidity and processability. Suitable polymers for the binder phase include polyimide (PI), polytetrafluoroethylene (PTFE), polyether ether ketone (PEEK), polyphenylene sulfide (PPS), and fluoropolymers, each selected for their high-temperature stability and dielectric properties.

In some embodiments, the rigid dielectric composite layers may additionally or alternatively include low-density inorganic compounds such as silica (SiO₂), magnesia (MgO), or naturally occurring mineral forms including sand and related silicate compositions. These materials can provide reduced density while maintaining electrical insulation and sufficient rigidity. Other suitable ceramics may include glass microspheres, clay minerals, or lightweight oxides that balance mechanical support with low mass, making them advantageous for applications requiring weight-sensitive solid-state battery designs.

The relative amounts of ceramic and polymer content in the rigid dielectric composite layers can be tailored to achieve desired mechanical, thermal, and processing characteristics. The composition may range from high-ceramic-content formulations for maximum rigidity to balanced polymer-ceramic blends for improved flexibility and ease of integration.

In high-ceramic-content formulations, the ceramic material may constitute 70% to 95% by volume, with the polymer binder making up the remainder. These compositions provide high Young's modulus values, typically ranging from 50 GPa to over 200 GPa, making them suitable for applications requiring maximum mechanical reinforcement and minimal deformation. Such high-ceramic-content layers are particularly advantageous in preventing pattern imprinting from the heating layer and ensuring uniform pressure distribution. The polymer binder in these compositions serves to enhance processability, prevent brittleness, and improve adhesion to adjacent battery layers. Common polymeric binders for these high-rigidity formulations include polyimide (PI), PEEK, or fluoropolymers, which exhibit high thermal and chemical stability.

For moderate-ceramic-content formulations, the ceramic fraction may range from 40% to 70% by volume, balancing mechanical stiffness with improved flexibility and manufacturability. These formulations exhibit Young's modulus values from 10 GPa to 50 GPa, ensuring sufficient rigidity for structural support while offering improved compliance under mechanical stress. Such configurations may be beneficial in applications requiring greater tolerance to thermal expansion mismatches within the battery stack. The polymer binder in these layers plays a more active role in ensuring toughness and preventing microcracking. Suitable binders for these formulations include polyphenylene sulfide (PPS), polytetrafluoroethylene (PTFE), and silicone-based polymers, which provide a combination of dielectric properties, temperature resistance, and durability.

In low-ceramic-content formulations, where the ceramic fraction constitutes 30% to 40% by volume, the focus is on enhanced flexibility and processability. These layers maintain a Young's modulus above 10 GPa but provide a degree of mechanical compliance to accommodate thermal expansion or localized stress variations in the battery stack. The polymer binder forms a more continuous phase, with the ceramic providing reinforcement. These formulations can be advantageous when seeking to optimize adhesion and integration within solid-state battery architectures. The polymer component in these formulations may include thermosetting resins, elastomeric polymers, or modified fluoropolymers, depending on the specific dielectric and thermal performance requirements.

In general, the ceramic fraction of the ceramic-polymer composite may vary widely depending on the desired balance of mechanical rigidity, thermal conductivity, dielectric strength, and processability. In some embodiments, the ceramic fraction may range from as little as about 0.01% by volume, where the ceramic functions primarily as a nucleating or reinforcing additive within a predominantly polymeric matrix, up to about 99.9% by volume, where the composite approaches the properties of a fully dense ceramic while retaining a minor polymeric binder phase to improve toughness and processability. The specific ranges of 30-95% described above represent illustrative examples, but the invention is not limited to those ranges. By allowing such broad compositional flexibility, the rigid dielectric composite layers can be tailored for diverse solid-state battery architectures and manufacturing techniques.

The processing method for forming these composite layers also influences their final properties. The ceramic and polymer components may be mixed as a slurry and cast into thin sheets via tape casting, ensuring uniform distribution and controlled thickness. Alternatively, the composite can be applied via screen printing, spray deposition, or roll coating, allowing for direct integration into battery manufacturing workflows. Hot pressing or sintering can be used to increase the density and mechanical strength of the composite layers, particularly for high-ceramic-content formulations.

The thermal conductivity of the rigid dielectric composite layers can be enhanced without compromising electrical insulation by selecting the ceramic phase. High-thermal-conductivity ceramics such as aluminum nitride (AlN), boron nitride (BN), silicon carbide (SiC), and beryllium oxide (BeO) provide significantly improved heat transfer while maintaining excellent dielectric properties. These materials exhibit thermal conductivities exceeding 20 W/m·K, with some, such as AlN and BeO, reaching values above 150 W/m·K, allowing for rapid heat dissipation without introducing electrical pathways that could interfere with battery operation.

### Manufacturing the Multilayer Structure

The multilayer structure may be manufactured using a variety of processes to achieve the desired mechanical stability, electrical insulation, and thermal regulation within a solid-state battery stack. The fabrication and integration of the conductive heating layer and the rigid dielectric composite layers can be adapted based on material selection, processing techniques, and performance requirements.

The rigid dielectric composite layers can be formed using ceramic fillers dispersed in a polymeric binder, ensuring a balance of mechanical rigidity, thermal conductivity, and electrical insulation. These layers may be produced as pre-formed sheets or applied as coatings through processes such as tape casting, extrusion, compression molding, spray deposition, dip coating, or screen printing. The ceramic and polymer content can be adjusted to tailor flexibility, processing characteristics, and compatibility with adjacent battery components. Depending on the formulation, post-processing techniques such as thermal curing, sintering, or solvent evaporation may be used to enhance mechanical strength and structural integrity. The rigid dielectric composite layers may also be engineered to include microstructural modifications, such as porosity control, to further optimize thermal and mechanical properties.

The conductive heating layer can be fabricated using metal foils, thin-film deposition, or printed conductive traces. Metal foils may be patterned, etched, or laser-cut to create controlled resistance paths, while thin films can be deposited using vacuum processes such as sputtering or chemical vapor deposition. Printed heating elements may be applied using conductive inks, pastes, or screen-printed circuits, allowing for flexible or patterned resistive heating configurations. The heating layer may include protective coatings, oxidation-resistant treatments, or encapsulation to improve durability and long-term performance. Depending on the battery design, the heating element can be embedded within an insulating substrate or directly bonded to the adjacent dielectric composite layers.

Assembly of the multilayer structure can be achieved through lamination, adhesive bonding, thermal compression, or co-processing with battery components. Bonding materials may include pressure-sensitive adhesives, thermally or UV-curable resins, or diffusion bonding techniques to ensure stable attachment between layers. In some embodiments, the layers may be co-sintered or compression-molded together to achieve seamless integration. Alternative fabrication methods, such as roll-to-roll processing or in-line deposition techniques, may be used for high-throughput manufacturing.

The final multilayer structure can undergo additional treatments to enhance performance and ease of integration within the battery stack. Edge sealing, laser trimming, surface modification, or encapsulation may be applied to improve structural robustness and ensure long-term reliability. The multilayer structure may also be designed for compatibility with specific battery assembly methods, including stacking, roll-to-stack integration, or direct lamination with current collector layers.

The manufacturing approach can be tailored based on application needs, allowing for variations in material selection, layer thickness, processing methods, and integration techniques. By offering flexibility in fabrication, the multilayer structure can be adapted to different solid-state battery architectures, ensuring scalability, efficiency, and improved thermal management across various high-performance energy storage applications.

### Solid-State Battery Incorporating the Multilayer Stack

The solid-state battery incorporating the multilayer stack benefits from enhanced thermal regulation, mechanical stability, and improved electrochemical performance. The multilayer stack is positioned between current collectors, facilitating controlled heating and uniform pressure distribution while maintaining structural integrity. This integration improves overall battery efficiency and durability across various battery architectures.

The battery may include electrodes (cathode and anode) and an electrolyte, which can be a solid electrolyte, a gel, or a hybrid configuration. The electrolyte facilitates ion transport between the electrodes during charge and discharge cycles, with the multilayer stack ensuring stable interfacial contact and mitigating mechanical or thermal stresses that could impact performance. The heating layer within the multilayer stack enables direct thermal regulation, maintaining the electrolyte within an optimal operating temperature range to enhance ionic conductivity, particularly under low-temperature conditions or during fast charging. The heating layer may be selectively activated based on battery conditions, preventing excessive energy consumption while ensuring consistent operation.

The current collectors, positioned adjacent to the electrodes, serve as electrically conductive interfaces that facilitate electron transport between the active electrode material and the external circuit. These collectors are typically composed of highly conductive materials such as copper, aluminum, or carbon-based foils, depending on the electrode chemistry and battery design. The integration of the multilayer stack between the current collectors allows for efficient heat distribution without directly interfering with ion transport across the electrolyte. Additionally, by ensuring uniform pressure across the battery stack, the multilayer structure helps to maintain consistent interfacial contact between the electrodes and the electrolyte, improving charge transfer efficiency and long-term cycle stability.

The rigid dielectric composite layers surrounding the heating layer provide structural reinforcement, electrical insulation, and pressure distribution within the battery stack. These layers prevent pattern imprinting from the heating element and ensure even compression, reducing localized stress concentrations that could affect long-term stability. Their mechanical properties contribute to maintaining the integrity of the battery stack over multiple charge-discharge cycles and thermal fluctuations.

The multilayer stack can be incorporated at different intervals within the battery stack, depending on the design and operational requirements. In some configurations, a multilayer stack may be positioned between every 3 to 30 cells to provide periodic thermal stabilization. This approach allows for localized heating within selected sections of the battery, enabling efficient thermal management without excessive energy consumption. The spacing of the multilayer structures can be optimized based on factors such as operating temperature ranges, charge-discharge rates, and overall cell architecture to balance efficiency and power demands.

The battery architecture can accommodate various electrode materials, solid or semi-solid electrolytes, and separator configurations, allowing for flexibility in design and manufacturing. The multilayer stack can be integrated into different battery form factors, including pouch cells, cylindrical cells, or prismatic cells, supporting a range of applications from consumer electronics to electric vehicles and large-scale energy storage systems.

By incorporating the multilayer stack, the battery benefits from improved manufacturability, enhanced reliability, and adaptability to different environmental conditions and performance requirements. This design allows for efficient thermal and mechanical management without interfering with electrochemical function, making it particularly suitable for applications demanding high energy density, rapid charging, and stable operation across a wide range of temperatures.

### Method for Manufacturing the Solid-State Battery

The manufacturing process for the solid-state battery incorporating the multilayer structure involves the integration of the conductive heating layer and rigid dielectric composite layers within the battery stack. This process may be implemented in various ways, depending on design preferences, material compatibility, and battery performance requirements. The multilayer structure can be separately fabricated and subsequently integrated into the battery stack, or alternatively, the rigid dielectric composite layers can be directly formed on the current collectors before incorporating the heating layer.

In one approach, the multilayer structure is pre-fabricated as a discrete unit before being inserted into the battery stack. This method begins with the formation of the rigid dielectric composite layers using ceramic-polymer formulations. The composite layers may be prepared as free-standing sheets via tape casting, extrusion, or compression molding. Alternatively, they can be applied as coatings onto temporary substrates using spray deposition, roll coating, or screen printing, followed by drying and thermal curing to achieve the desired mechanical properties. If necessary, post-processing such as hot pressing or sintering can be used to increase density and rigidity.

The conductive heating layer is then formed and positioned between the two rigid dielectric composite layers. Depending on the configuration, the heating layer may be a metal foil, a vacuum-deposited thin film, or a printed resistive trace applied using screen printing or inkjet deposition. In cases where a foil is used, the metal sheet can be etched or patterned to define the resistance path. The composite layers are laminated or bonded onto the heating layer using pressure-sensitive adhesives, thermally cured bonding agents, or mechanical compression. Additional processing steps, such as plasma treatment or surface texturing, may be employed to enhance adhesion between layers.

Once the multilayer structure is fully assembled, it is integrated into the battery stack. The structure is positioned between current collector layers at designated intervals, typically every 3 to 30 cells, to optimize thermal management. During battery assembly, pressure is applied to ensure intimate contact between all layers, followed by an encapsulation or sealing process to protect the battery from environmental exposure.

In an alternative approach, the multilayer structure is prefabricated as a discrete unit before being inserted into the battery stack, wherein the rigid dielectric composite layers are formed directly onto the opposite sides of a conductive heating layer. This method begins with the conducting heating layer serving as a foundational substrate. The composite layers may be prepared via tape casting, extrusion, or compression molding onto the conductive heating layer. Alternatively, they can be applied as coatings using spray deposition, roll coating, or screen printing, followed by drying and thermal curing to achieve the desired mechanical properties. If necessary, post-processing, such as hot pressing or sintering, can be used to increase density and rigidity.

Depending on the configuration, the heating layer may be a metal foil or a printed resistive trace. In the case of a metal foil, the metal sheet can be etched or patterned to define the resistance path. The composite layers are bonded onto the heating layer using pressure-sensitive adhesives, thermally cured bonding agents, or mechanical compression. Additional processing steps, such as plasma treatment or surface texturing, may be employed to enhance adhesion between layers.

Once the multilayer structure is fully assembled, it is integrated into the battery stack. The structure is positioned between current collector layers at designated intervals, typically every 3 to 30 cells, to optimize thermal management. During battery assembly, pressure is applied to ensure intimate contact between all layers, followed by an encapsulation or sealing process to protect the battery from environmental exposure.

In yet another alternative approach, the rigid dielectric composite layers can be directly formed on the current collector layers before incorporating the heating layer. In this approach, the composite material is applied as a coating or laminated onto the current collector surfaces, forming an insulating and mechanically stable interface. The composite layer may be deposited using spray coating, dip coating, or screen printing, followed by a thermal curing step to achieve the desired rigidity. If needed, high-temperature sintering or hot pressing can be applied to densify the composite layer.

Following the formation of the composite layers on the current collector, the conductive heating layer is then introduced between the prepared current collector. The heating layer may be deposited directly onto one of the composite-coated current collector surfaces using sputtering, chemical vapor deposition, or screen printing. Alternatively, a pre-fabricated heating element, such as a patterned metal foil or printed resistive trace, can be laminated between the composite-coated current collector. This approach allows for precise integration of the heating layer without requiring additional bonding steps for separate dielectric layers.

After the heating layer is positioned, the battery stack is assembled by aligning the electrolyte, separator, and electrode layers with the multilayer heating structure at designated positions. The stack is then compressed and bonded, ensuring stable mechanical contact and optimal electrochemical performance. Encapsulation or sealing may be applied to protect the battery from moisture, oxidation, and mechanical stress.

These manufacturing approaches allow for flexibility in integrating the multilayer structure within the solid-state battery while maintaining mechanical stability, electrical insulation, and controlled thermal management. By optimizing the integration method, the battery can achieve enhanced reliability, improved charge-discharge efficiency, and extended cycle life across various applications.

### Method for Heating the Solid-State Battery

The method for heating the solid-state battery involves applying an electrical current to the conductive heating layer embedded within the multilayer structure, generating heat through resistive heating. This controlled heating raises the temperature of the electrolyte, improving ionic conductivity and reducing internal resistance, which is particularly beneficial for operation at low temperatures and under high-power demands. The heating process ensures that the electrolyte remains within an optimal temperature range, enhancing charge transport efficiency and enabling consistent battery performance across a wide range of environmental conditions.

In cold environments, where solid-state electrolytes typically exhibit reduced ionic mobility, the heating layer can be activated prior to or during charging to prevent performance degradation. By preheating the electrolyte, the battery can accept charge more efficiently, reducing charge times and mitigating potential damage from lithium plating or other low-temperature failure modes. Similarly, the heating system can maintain electrolyte temperature during discharge, ensuring stable power output and minimizing voltage drop in demanding applications such as electric vehicle acceleration or peak energy delivery in grid storage.

The activation of the heating layer may be controlled dynamically based on battery conditions, including temperature, charge level, and power demand. A battery management system (BMS) or external control unit can regulate the application of current to the heating layer, ensuring that heating is applied only when necessary to optimize energy consumption. The heating layer may operate continuously, intermittently, or in pulsed modes to maintain thermal stability while minimizing power draw. Additionally, multiple heating layers can be incorporated at different intervals within the battery stack, such as between every 3 to 30 cells, allowing for localized heating and tailored thermal regulation throughout the battery. The heating layer may be powered by an external charging system or using the solid-state batteries themselves.

To improve thermal efficiency, the rigid dielectric composite layers adjacent to the heating element help retain heat, reducing energy loss and ensuring even temperature distribution across the battery stack. The heating layer may also be configured to provide targeted heating, directing thermal energy toward specific regions of the electrolyte or electrode interfaces to address localized resistance variations. This approach enhances overall battery longevity by reducing thermal cycling stresses and preventing non-uniform heating effects that could lead to mechanical degradation over time.

The method for heating the solid-state battery is adaptable to various battery architectures, including fully solid-state designs, hybrid solid-liquid electrolyte configurations, and gel-electrolyte systems. By integrating heating functionality directly within the battery stack, this approach eliminates the need for external thermal management systems, reducing complexity and improving overall energy efficiency. This method is particularly advantageous for applications requiring reliable operation under extreme temperatures, fast charging, or high-power discharge scenarios, such as electric vehicles, aerospace systems, and stationary energy storage solutions.

### Patterned Conductive Heating Layers

In certain embodiments, the conductive heating layer is implemented as a patterned structure rather than a fully continuous film. As used herein, a “patterned” conductive heating layer refers to a non-continuous conductive structure that includes interruptions which define resistive paths for current flow. The term “interruptions” encompasses any discontinuity in the conductive layer, including spaces, breaks, or regions of non-conductive material, that cause current to traverse a longer or redirected pathway. A fully continuous conductive sheet without such interruptions is not considered patterned.

The introduction of interruptions provides improved control over resistance and heating, enabling localized or tunable thermal profiles within the solid-state battery stack. Examples include interruptions that define serpentine traces, interdigitated electrodes, grid structures, or segmented heating zones. These designs allow for targeted heat generation, improved energy efficiency, and the ability to manage localized cold spots or high-resistance regions in the battery.

However, the presence of interruptions also produces a non-uniform surface profile. During stack compression, the interruptions can create stress concentrations that imprint into adjacent electrolyte or electrode layers, risking deformation, delamination, or fracture. The rigid dielectric composite layers described herein counteract these effects by distributing pressure across the patterned heating layer, thereby preventing the interruptions from imprinting into surrounding layers and maintaining structural and electrochemical integrity.

In some embodiments, the interruptions are at least partially filled with a rigid dielectric material. Filling the interruptions provides a flush surface, enhances uniformity of pressure distribution, and further strengthens the multilayer structure. The dielectric material may be deposited, molded, or co-sintered with the conductive layer, ensuring robust integration without disrupting the intended resistive pathways.

By integrating a patterned conductive heating layer having interruptions with rigid dielectric reinforcement, and optionally filling the interruptions with dielectric material, the present disclosure provides both finely controlled thermal regulation and reliable mechanical stability. This design enables improved manufacturability, reduced mechanical degradation, and enhanced durability in high-performance solid-state batteries.

### Filling Interruptions in the Patterned Conductive Heating Layer

In configurations where the conductive heating layer is patterned rather than continuous, the void spaces (also referred to herein as interruptions) within the pattern may be filled with a rigid dielectric material to prevent mechanical fracture, ensure uniform pressure distribution, and enhance structural integrity. As used herein, a “rigid dielectric” refers to an electrically insulating material having a Young's modulus greater than 1 GPa, preferably greater than 10 GPa, consistent with the rigid dielectric composite layers described above. Left unfilled, these void spaces or interruptions can introduce weak points in the multilayer structure, leading to stress concentrations, localized deformation, and potential failure under compression or thermal cycling. By filling these spaces, the structure maintains consistent mechanical support while preserving the functionality of the heating layer.

This filling process can be achieved through various techniques depending on the material and manufacturing requirements of the battery. One approach involves depositing or printing the rigid dielectric directly into the void spaces before assembling the multilayer structure, ensuring seamless integration with the heating layer. Another method employs co-sintering, where the dielectric filler is bonded to the heating layer at high temperatures, forming a unified and reinforced structure. In some cases, pre-formed dielectric inserts that match the void pattern can be laminated onto the heating layer, providing precise structural stabilization.

An alternative approach is overmolding, where a dielectric material is molded onto the patterned conductive heating layer, flowing into the void spaces and solidifying to form a mechanically stable, electrically insulating, and thermally regulated structure. Overmolding ensures complete encapsulation of the heating layer while preserving its designed pattern, preventing fracture and improving durability under repeated mechanical and thermal stresses.

The choice of dielectric material depends on the required mechanical rigidity, thermal conductivity, and electrical insulation. High-modulus ceramics such as alumina, zirconia, or boron nitride provide superior mechanical reinforcement and electrical insulation, while polymer-ceramic composites offer a balance of flexibility and structural stability. By carefully selecting the filling method and material, the void spaces or interruptions in the patterned heating layer are effectively eliminated, ensuring reliable operation, optimal heat transfer, and long-term durability within the solid-state battery stack.

### Description of a Solid-State Battery

A solid-state battery cell may comprise a solid-state electrolyte, a cathode, and an anode. A solid-state electrolyte may be referred to as a solid-state ionic conductive material. A cathode may be referred to as a composite cathode comprising solid-state ionic conductive material in the form of a catholyte. An anode may be referred to as a composite anode comprising solid-state ionic conductive material in the form of an anolyte as an ionic conductive media.

A solid-state ionic conductive material is a type of material that can selectively allow a specific charged element to pass through under the presence of an electric field or chemical potential, such as concentration differences.

While this solid-state ionic conductive material allows ions to migrate through, it may not allow electrons to pass easily.

The ions may carry 1, 2, 3, 4, or more positive charges. Examples of the charged ions include but are not limited to H⁺, Li⁺, Na⁺, K⁺, Ag⁺, Mg²⁺, Zn²⁺, Fe³⁺, Al³⁺, etc.

The ionic conductivity of the corresponding ions is preferably to be >10⁻⁷ S/cm. It is preferable to have lower electrical conductivity (≤10⁻⁷ S/cm).

Examples of a solid-state ionic conductive material include but are not limited to a garnet-like structure oxide material with the general formula:

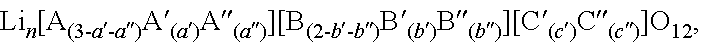

a. where A, A′, and A″ stand for a dodecahedral position of the crystal structure, i. where A stands for one or more trivalent rare earth elements, ii. where A′ stands for one or more alkaline earth elements, iii. where A″ stands for one or more alkaline metal elements other than Li, and iv. wherein 0≤a′≤2 and 0≤a″≤1;
b. where B, B′, and B″ stand for an octahedral position of the crystal structure, i. where B stands for one or more tetravalent elements, ii. where B′ stands for one or more pentavalent elements, iii. where B″ stands for one or more hexavalent elements, and iv. wherein 0≤b′, 0≤b″, and b′+b″≤2;
c. where C′ and C″ stand for a tetrahedral position of the crystal structure, i. where C′ stands for one or more of Al, Ga, and boron, ii. where C″ stands for one or more of Si and Ge, and iii. wherein 0≤c′≤0.5 and 0 0.4; and
d. wherein n=7+a′+2·a″−b′−2·b″−3·c′−4·c″ and 4.5≤n≤7.5.

In another example, a solid-state ionic conductive material includes perovskite-type oxides such as (Li, La)TiO₃ or doped or replaced compounds.

In yet another example, a solid-state ionic conductive material includes NASICON-structured lithium membrane, such as LAGP (Li₁₋ₓAlₓGe₂₋ₓ(PO₄)₃), LATP (Li₁₊ₓAlₓTi₂₋ₓ(PO₄)₃) and these materials with other elements doped therein.

In yet another example, a solid-state ionic conductive material includes anti-perovskite structure materials and their derivatives, such as the composition of Li₃OCl, Li₃OBr, and Li₃OI.

In yet another example, a solid-state ionic conductive material includes the Li₃YH₆(H═F, Cl, Br, I) family of materials, Y can be replaced by other trivalent elements.

In yet another example, a solid-state ionic conductive material includes Li₂ₓS_{x+w+5z}M_{y}P_{2z}, where x is 8-16, y is 0.1-6, w is 0.1-15, z is 0.1-3, and M is selected from the group consisting of lanthanides, Group 3, Group 4, Group 5, Group 6, Group 7, Group 8, Group 9, Group 12, Group 13, and Group 14 atoms, and combinations thereof.

In yet another example, a solid-state ionic conductive material includes argyrodites materials with the general formula: Li₁₂₋ₘ₋ₓ(MₘY₄ ²⁻)Y₂₋ₓ ²⁻X^{x-}, wherein M^{m+}=B³⁺, Ga³⁺, Sb³⁺, Si⁴⁺, Ge⁴⁺, P⁵⁺, As⁵⁺, or a combination thereof; Y²⁻=O²⁻, S²⁻, Se²⁻, Te²⁻, or a combination thereof; X⁻=F⁻, Cl⁻, Br⁻, I⁻, or a combination thereof; and x is in the range of 0≤x≤2.

In yet another example, a solid-state ionic conductive material includes argyrodites materials with the general formula: Li₁₈₋₂ₘ₋ₓM₂^{m+}Y₍₉₋ₓ₎₊ₙXₓ, wherein M^{m+}=B³⁺, Ga³⁺, Sb³⁺, Si⁴⁺, Ge⁴⁺, P⁵⁺, As⁵⁺, or a combination thereof; Y²⁻=O²⁻, S²⁻, Se²⁻, Te²⁻, or a combination thereof; X⁻=F⁻, Cl⁻, Br⁻, I⁻, or a combination thereof; and x is in the range of 0≤x≤2.

In yet another example, a solid-state ionic conductive material includes alkali metal halides with the general formula AₐM_{b} ^{m+}M'_{b}′ ^{m'+}X_{a+mb+m′b′}, where A=Li⁺, Na⁺, K⁺, or a combination thereof, X⁻=F⁻, Cl⁻, Br⁻, I⁻, or a combination thereof, M^{m+}=Ti²⁺, V²⁺, Cr²⁺, Mn²⁺, Fe²⁺, Co²⁺, Ni²⁺, Cu²⁺, Zn²⁺, Cd²⁺, Mg²⁺, Pb²⁺, Y³⁺, Sc³⁺, Lu³⁺, La³⁺, Al³⁺, Ga³⁺, In³⁺, Er³⁺, Ho³⁺, Ti³⁺, Cr³⁺, V³⁺, Hf⁴⁺, Zr⁴⁺, V⁴⁺, Ti⁴⁺, Mo⁴⁺, W⁴⁺, V⁵⁺, Nb⁵⁺, Ta⁵⁺, Cr⁶⁺, Mo⁶⁺, W⁶⁺, etc., and M′^{m+}may be metal with the same valance state as M^{m+} when b′ is greater than 0, or an aliovalent substitution when b′ is greater than 0.

In some instances, a solid-state electrolyte layer may be a ceramic-polymer composite, composed of a solid-state ionic conductive material and a binding polymer.

A binding polymer may include, for example, polyolefins (e.g., polyethylenes, poly(butene-1), poly(n-pentene-2), polypropylene, polytetrafluoroethylene), polyamines (e.g., poly(ethylene imine) and polypropylene imine (PPI)); polyamides (e.g., polyamide (Nylon), poly(ϵ-caprolactam) (Nylon 6), poly(hexamethylene adipamide) (Nylon 66)), polyimides (e.g., polyimide, polynitrile, and poly(pyromellitimide-1,4-diphenyl ether) (Kapton®) (NOMEX®) (KEVLAR®)); polyether ether ketone (PEEK); vinyl polymers (e.g., polyacrylamide, poly(2-vinyl pyridine), poly(N-vinylpyrrolidone), poly(methylcyanoacrylate), poly(ethylcyanoacrylate), poly(butylcyanoacrylate), poly(isobutylcyanoacrylate), poly(vinyl acetate), poly (vinyl alcohol), poly(vinyl chloride), poly(vinyl fluoride), poly(2-vinyl pyridine), vinyl polymer, polychlorotrifluoro ethylene, and poly(isohexylcynaoacrylate)); polyacetals; polyesters (e.g., polycarbonate, polybutylene terephthalate, polyhydroxybutyrate); polyethers (poly(ethylene oxide) (PEO), poly(propylene oxide) (PPO), poly(tetramethylene oxide) (PTMO)); vinylidene polymers (e.g., polyisobutylene, poly(methyl styrene), poly(methylmethacrylate) (PMMA), poly(vinylidene chloride), and poly(vinylidene fluoride)); polyaramides (e.g., poly(imino-1,3-phenylene iminoisophthaloyl) and poly(imino-1,4-phenylene iminoterephthaloyl)); polyheteroaromatic compounds (e.g., polybenzimidazole (PBI), polybenzobisoxazole (PBO) and polybenzobisthiazole (PBT)); polyheterocyclic compounds (e.g., polypyrrole); polyurethanes; phenolic polymers (e.g., phenol-formaldehyde); polyalkynes (e.g., polyacetylene); polydienes (e.g., 1,2-polybutadiene, cis or trans- 1,4-polybutadiene); polysiloxanes (e.g., poly(dimethylsiloxane) (PDMS), poly(diethylsiloxane) (PDES), polydiphenylsiloxane (PDPS), and polymethylphenylsiloxane (PMPS)); and inorganic polymers (e.g., polyphosphazene, polyphosphonate, polysilanes, polysilazanes). In some embodiments, the polymer may be selected from poly(n-pentene-2), polypropylene, polytetrafluoroethylene, polyamides (e.g., polyamide (Nylon), poly(ϵ-caprolactam) (Nylon 6), poly(hexamethylene adipamide) (Nylon 66)), polyimides (e.g., polynitrile, and poly(pyromellitimide-1,4-diphenyl ether) (Kapton®) (NOMEX®) (KEVLAR®)), polyether ether ketone (PEEK).

A ceramic-polymer composition may contain an ionic conducting salt. An example of an ionic conducting salt may include, for example, lithium bis(trifluoromethanesulfonyl)imide (LiTFSI) and lithium bis(fluorosulfonyl)imide (LiFSI), lithium bis(oxalato)borate (LiBOB), lithium Difluro(oxalato)borate (LiDFOB) , LiSCN, LiBr, LiI, LiClO₄, LiAsF₆, LiSO₃CF₃, LiSO₃CH₃, LiBF₄, LiB(Ph)₄, LiPF₆, LiC(SO₂CF₃)₃, LiN(SO₂CF₃)₂), LiNO₃, sodium bis(trifluoromethanesulfonyl)imide (NaTFSI) and sodium bis(fluorosulfonyl)imide (NaFSI), sodium bis(oxalato)borate (NaBOB) Sodium-difluoro(oxalato)borate (NaDFOB), NaSCN, NaBr, NaI, NaAsF₆, NaSO₃CF₃, NaSO₃CH₃, NaBF₄, NaPF₆, NaN(SO₂F)₂, NaClO₄, NaN(SO₂CF₃)₂, NaNO₃, magnesium bis(trifluoromethanesulfonyl)imide (Mg(TFSI)₂) and magnesium bis(fluorosulfonyl)imide (Mg(FSI)₂), magnesium bis(oxalato)borate (Mg(BOB)₂), magnesium Difluro(oxalato)borate (Mg(DFOB)₂), Mg(SCN)₂, MgBr₂, MgI₂, Mg(ClO₄)₂, Mg(AsF₆)₂, Mg(SO₃CF₃)₂, Mg(SO₃CH₃)₂, Mg(BF₄)₂, Mg(PF₆)₂, Mg(NO₃)₂, Mg(CH₃COOH)₂, potassium bis(trifluoromethanesulfonyl)imide (KTFSI) and potassium bis(fluorosulfonyl)imide (KFSI), potassium bis(oxalato)borate (KBOB), potassium Difluro(oxalato)borate (KDFOB) , KSCN, KBr, KI, KClO₄, KAsF₆, KSO₃CF₃, KSO₃CH₃, KBF₄, KB(Ph)₄, KPF₆, KC(SO₂CF₃)₃, KN(SO₂CF₃)₂), KNO₃, Al(NO₃)₂, AlCl₃, Al₂(SO₄)₃, AlBr₃, AlI₃, AlN, AlSCN, Al(ClO₄)₃.

A solid-state battery cell may comprise a mixture of two or more solid-state ionic conductive materials. For example, the solid-state electrolyte, catholyte, and anolyte may all have the same solid-state ionic conductive material. Alternatively, the solid-state electrolyte, catholyte, and anolyte may all have a different solid-state ionic conductive material.

A composite cathode layer may be formed onto a positive current collector. A positive current collector may include, for example, aluminum foil.

A composite cathode layer may comprise an active cathode active material, an inactive binder, an electronically conductivity additive, and an ionic conducting media known as the catholyte.

Active cathode materials may include intercalation material such as, for example, layered YMO₂, Y-rich layered Y₁₊ₓM₁₋ₓO₂, spinel YM₂O₄, olivine YMPO₄, silicate Y₂MSiO₄, borate YMBO₃, tavorite YMPO₄F (where M is Fe, Co, Ni, Mn, Cu, Cr, etc.), (where Y is Li, Na, K, Mg, Zn, Al, etc.), vanadium oxides, sulfur, lithium sulfide, iron sulfide, FeF₃, LiSe.

In the case of a lithium intercalation, active cathode materials may include, for example, lithium iron phosphate (LiFePO₄), lithium cobalt oxide (LiCoO₂), lithium manganese oxide (LiMn₂O₄), and lithium nickel oxide (LiNiO₂), lithium nickel cobalt manganese oxide (LiNiₓCo_{y}Mn_{z}O₂, 0.95≥x≥0.5, 0.3≥y≥0.025, 0.2≥z≥0.025), lithium nickel cobalt aluminum oxide (LiNiₓCo_{y}Al_{z}O₂, 0.95≥x≥0.5, 0.3≥y≥0.025, 0.2≥z≥0.025), lithium nickel manganese spinel (LiNi_{0.5}Mn_{1.5}O₄), etc.

Active cathode materials may be single crystal, polycrystalline, or amorphous.

Active cathode material may be coated with a protected layer to enhance chemical stability with a catholyte.

Protective coatings may include, for example, carbon, lithium niobate (LiNbO₃), lithium borate (Li₂B₄O₇), lithium zirconate (Li₂ZrO₃), lithium titanate (Li₄Ti₅O₁₂), aluminum oxide (Al₂O₃), etc.

A composite cathode layer may include an inactive binder such as, for example, polyvinylidene fluoride, polyacrylic acid, lotader, carboxymethyl cellulose, styrene-butadiene rubber, sodium alginate, etc.

A composite cathode layer may include an inactive electronically conductive additive such as, for example, graphene, reduced graphene oxide, carbon nanotubes, carbon black, Super P, acetylene black, vapor-grown carbon fibers, carbon nanofibers or a conductive polymer such as polyaniline, polypyrrole, poly(3,4-ethylenedioxythiophene (PEDOT), polyphenylene vinylene etc.

A composite cathode layer may contain a small amount of inactive lithium additives such as lithium nitrate or lithium bis(oxalato)borate to serve as an excess lithium source.

An anode layer may be formed onto a negative current collector. A negative current may include, for example, copper foil.

An anode layer may include a composite an anode layer.

A composite anode layer may comprise an active anode material, an inactive binder, an electronically conductivity additive, and an ionic conducting media known as the anolyte.

An active anode material may interact with ions through various mechanisms including, but not limited to, intercalation, alloying, plating, or conversion.

An active anode material may include, for example, lithium powder, titanium oxide, silicon, tin oxide, germanium, antimony, silicon oxide, iron oxide, cobalt oxide, ruthenium oxide, molybdenum oxide, molybdenum sulfide, chromium oxide, nickel oxide, manganese oxide, carbon-based materials (hard carbons, soft carbons, graphene, graphite's, carbon nanofibers, carbon nanotubes, etc.), or a combination thereof.

In the case of lithium powder, alloying materials may be introduced into the composite anode structure which may include, for example, tin, zinc, indium, magnesium, etc.

Active anode materials may be single crystal, polycrystalline, or amorphous.

Active anode material may be coated with a protected layer to enhance chemical stability with the anolyte.

Protective coatings may include, for example, carbon, lithium niobate (LiNbO₃), lithium borate (Li₂B₄O₇), lithium zirconate (Li₂ZrO₃), lithium titanate (Li₄Ti₅O₁₂), aluminum oxide (Al₂O₃), etc.

A composite anode layer may include an inactive binder such as, for example, polyvinylidene fluoride, polyacrylic acid, lotader, carboxymethyl cellulose, styrene-butadiene rubber, sodium alginate, etc.

A composite anode layer may include an inactive electronically conductive additive such as, for example, graphene, reduced graphene oxide, carbon nanotubes, carbon black, Super P, acetylene black, vapor-grown carbon fibers, carbon nanofibers or a conductive polymer such as polyaniline, polypyrrole, poly(3,4-ethylenedioxythiophene (PEDOT), polyphenylene vinylene etc.

A composite anode layer may contain a small amount of inactive lithium additives such as lithium nitrate or lithium bis(oxalato)borate to serve as an excess lithium source.

An anode layer may include a metal anode layer.

A metal anode layer may include lithium metal which is commonly referred to in the art as a lithium metal battery.

Alternatively, a metal anode layer may include sodium, potassium, manganese, magnesium, zinc, iron, aluminum, etc.

In some instances, a solid-state battery may be devoid of an anode layer which is commonly referred to in the art as an anodeless or lithium-free solid-state battery.

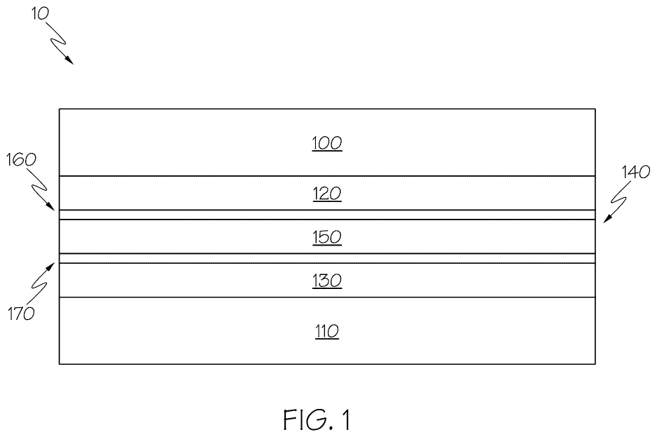

### Description of FIG. 1

FIG. 1 illustrates a cross-sectional schematic of a solid-state battery stack (10) incorporating the multilayer structure for thermal regulation and mechanical stability. The figure depicts a first electrode (100) and a second electrode (110), each associated with a current collector (120, 130). The electrodes contain active materials responsible for ion transport, while the current collectors provide electron conduction between the electrodes and the external circuit.

Positioned between the current collectors is the multilayer structure (140), which includes a conductive heating layer (150) and two rigid dielectric composite layers (160, 170). The heating layer is configured to generate heat through resistive heating when an electrical current is applied, raising the temperature of the battery stack to improve electrolyte conductivity and enhance charge transport efficiency. The rigid dielectric composite layers (160, 170), which are positioned on either side of the heating layer, serve multiple functions: they provide mechanical support, distribute pressure evenly, and electrically insulate the heating layer from adjacent components. The rigidity of these layers ensures that mechanical stresses from battery stacking and operation do not cause deformation or localized compression inconsistencies.

An electrolyte is situated between the electrodes, allowing ion transport during charge and discharge cycles. The multilayer structure (140), positioned between the current collectors, facilitates controlled heating of the electrolyte without directly interfering with electrochemical activity. This placement allows for localized thermal regulation, ensuring that the electrolyte remains within an optimal temperature range for efficient operation.

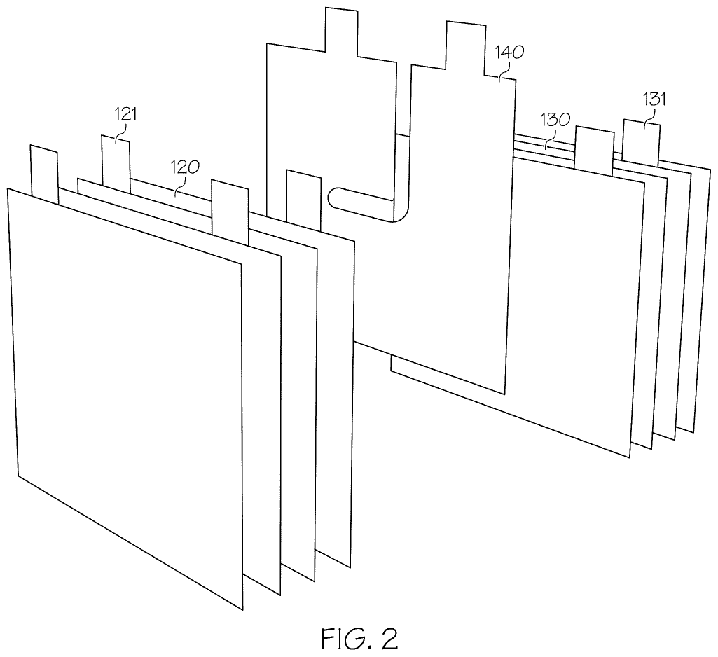

### Description of FIG. 2

FIG. 2 illustrates an exploded schematic of a portion of a solid-state battery stack showing the arrangement of current collectors and the multilayer structure according to the present disclosure. A first current collector (120) is shown with an associated tab (121), and a second current collector (130) is shown with an associated tab (131). Positioned between the adjacent current collectors is a multilayer structure (140) that embodies the basic principles of the invention.

For clarity of illustration, the electrochemical components of the solid-state battery—including the positive electrode (cathode), negative electrode (anode), and solid-state electrolyte separator—are not shown in FIG. 2. In a complete battery stack, these layers are interposed between the current collectors, and the multilayer structure (140) is inserted between collectors of adjacent cells.

The multilayer structure (140) comprises a conductive heating layer positioned between opposing rigid dielectric composite layers. When an electrical current is applied, the conductive heating layer generates resistive heat. This heat is transferred directly to the adjacent current collectors (120, 130), which in turn distribute the thermal energy to the electrodes and electrolyte layers of the electrochemical cells. In this way, the heating function is embedded within the stack while maintaining electrical isolation from the current collectors.

The rigid dielectric composite layers flanking the conductive heating layer provide mechanical stiffness and electrical insulation, ensuring that compressive forces within the stack are evenly distributed and that any patterning of the conductive heating layer does not imprint into adjacent layers. By combining localized resistive heating with structural reinforcement, the multilayer structure both improves ionic conductivity under challenging temperature conditions and enhances long-term mechanical stability.

The tabs (121, 131) extending from the current collectors facilitate electrical connection to external circuitry, while the multilayer structure (140) remains electrically isolated. The footprint and geometry of the multilayer structure can be configured for compatibility with surrounding current collectors, enabling straightforward integration into pouch-cell, prismatic, or cylindrical solid-state battery architectures. This design provides improved manufacturability, internal thermal regulation through direct current collector heating, and enhanced durability, which are core aspects of the present invention.

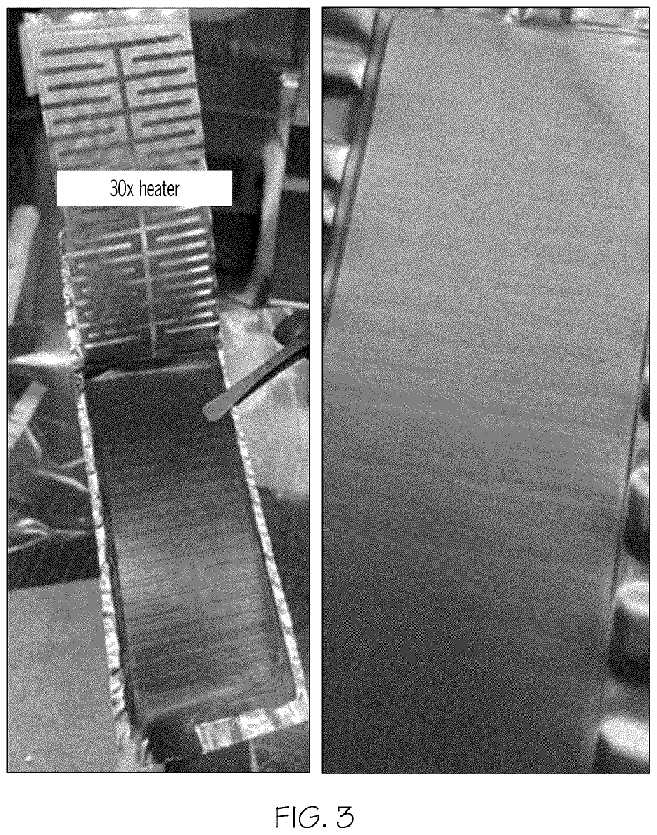

### Description of FIG. 3

FIG. 3 includes photographic images illustrating imprinting that can occur when a patterned conductive heating layer is incorporated into a battery stack without adequate reinforcement.

In the left-hand image, a patterned heating element is shown being lifted away from an adjacent copper current collector foil (Cu—Cu foil). The outline of the heater's pattern can be seen transferred into the foil surface, demonstrating how localized features of the conductive layer can mechanically imprint under stack pressure.

In the right-hand image, the patterned heater was positioned within the middle of a pouch cell during assembly and processing. After disassembly, the surface of the pouch cell shows the imprint of the heater pattern, further evidencing how discontinuities in a non-continuous conductive layer can propagate into neighboring battery components.

These results highlight the mechanical challenges addressed by the present invention. The rigid dielectric composite layers of the disclosed multilayer structure are specifically designed to surround the conductive heating layer, distribute compressive loads uniformly, and prevent heater patterns from imprinting into adjacent electrodes, electrolytes, or current collectors. By mitigating pattern transfer, the multilayer structure improves the mechanical stability, durability, and electrochemical reliability of solid-state batteries incorporating internal heating elements.

### Applications

The multilayer structure described in this description provides enhanced thermal regulation, mechanical stability, and improved electrochemical performance, making it advantageous for a wide range of battery applications across multiple industries. By integrating a conductive heating layer with rigid dielectric composite layers, this design enables controlled internal heating without compromising battery performance, making it especially useful in applications where temperature sensitivity, fast charging, or high-power discharge are required.

### Electric Vehicles (EVs) and Transportation

Solid-state batteries are increasingly being considered for electric vehicles, hybrid-electric vehicles, and other transportation applications due to their higher energy density, improved safety, and longer lifespan compared to conventional lithium-ion batteries. However, cold temperatures can drastically reduce battery performance by decreasing the ionic conductivity of the solid electrolyte. The integrated heating layer within the multilayer structure allows for preheating of the battery stack before charging or operation, ensuring optimal performance in cold climates. Additionally, the ability to regulate temperature minimizes charge time variability, enabling faster and more predictable charging cycles for EV owners.

For public transit systems, electric aircraft, and electric marine vessels, where consistent performance is required across a wide range of environmental conditions, this thermal regulation technology ensures stable battery operation while reducing reliance on external heating systems, which can add weight and consume additional energy.

Transportation may include personal vehicles such as snowmobiles, all-terrain vehicles, golf carts, etc.

### Grid Energy Storage and Renewable Integration

The demand for large-scale energy storage to support renewable energy sources (such as solar and wind) is growing. However, solid-state batteries used in stationary grid storage applications must maintain consistent efficiency across a wide range of environmental conditions. The multilayer heating structure allows for temperature regulation in large-scale battery arrays, ensuring stable operation during seasonal temperature fluctuations.

For off-grid or remote energy storage solutions, where battery maintenance and external thermal management are difficult, the integrated self-heating capability ensures reliability and longevity. The ability to periodically heat the electrolyte also reduces degradation mechanisms that occur under prolonged exposure to low-temperature cycling, extending battery lifespan and improving overall system efficiency.

### Aerospace and High-Altitude Applications

In aerospace and high-altitude applications, including satellites, unmanned aerial vehicles (UAVs), and space exploration, batteries are exposed to extremely low temperatures where conventional lithium-ion batteries suffer severe performance losses. The ability to generate localized heating within the battery stack ensures that the solid-state electrolyte remains operational in extreme environments, making this multilayer structure particularly well-suited for:
Satellites operating in low Earth orbit (LEO) or deep space missions.
Electric propulsion systems for UAVs or electric aircraft.
Lunar or Martian surface operations, where temperature fluctuations can be extreme.

By eliminating the need for external battery heating components, this design reduces weight and complexity, making it highly attractive for weight-sensitive applications such as aerospace and defense technologies.

### Consumer Electronics and Wearable Devices

Next-generation wearable electronics, medical devices, and portable consumer electronics benefit from solid-state batteries due to their increased safety and form factor flexibility. However, miniaturized batteries often suffer from temperature-related efficiency losses, especially in cold environments where users rely on their devices in outdoor or extreme settings.

The integration of a thin, patterned heating layer within the battery stack allows:
Smartwatches, augmented reality (AR) glasses, and fitness trackers to maintain peak performance in varying temperatures.
Medical implants or health monitoring devices to operate reliably without being affected by low ambient temperatures.
Ruggedized portable electronics used in industrial or military applications to function in extreme climates.

The localized and efficient heating provided by the multilayer structure ensures that these devices maintain consistent power output, improving user experience and device longevity.

### Industrial and High-Power Applications

Many industrial applications, such as robotics, electric forklifts, and automated machinery, rely on high-power battery systems that must perform consistently regardless of operating temperature. The multilayer structure ensures that:
Cold-temperature startup times are minimized.
Fast charging is enabled without the risk of lithium plating or electrolyte degradation.
High discharge rates can be maintained without thermal runaway concerns.

In sectors such as mining, construction, and oil and gas exploration, where battery-powered equipment operates in sub-zero conditions, the ability to self-regulate internal temperature significantly improves operational uptime and efficiency.

Although various embodiments of the disclosure have been shown and described, modifications may occur to those skilled in the art upon reading the specification. The present application includes such modifications and is limited only by the scope of the claims.

What is claimed is:

1. A multilayer structure comprising:
a conductive heating layer configured to generate heat through resistive heating when an electrical current is applied; and
a first rigid dielectric composite layer positioned on a first side of the conductive heating layer and a second rigid dielectric composite layer positioned on a second side of the conductive heating layer,
wherein the first and second rigid dielectric composite layers are electrically insulating and have a Young's modulus greater than 1 GPa.

2. The multilayer structure of claim 1, wherein the conductive heating layer comprises a patterned conductive heating layer, the patterned conductive heating layer comprising a non-continuous conductive structure having interruptions that define resistive paths configured to regulate current flow and heat distribution.

3. The multilayer structure of claim 2, wherein the interruptions form one or more of a serpentine trace, interdigitated electrode, grid structure, or segmented heating zone.

4. The multilayer structure of claim 2, wherein void spaces defined by the interruptions are at least partially filled with a rigid dielectric material to enhance pressure distribution uniformity and integrity which help to avoid pressure nonuniformity induced performance issues.

5. The multilayer structure of claim 1, wherein at least one of the first and second rigid dielectric composite layers comprises a ceramic-polymer composite having a ceramic fraction of 0.01% to 99.9% by volume.

6. The multilayer structure of claim 1, wherein at least one of the first and second rigid dielectric composite layers comprises a ceramic selected from alumina, zirconia, silicon carbide, boron nitride, hafnia, yttria-stabilized zirconia, silica, magnesia, sand, or other low-density inorganic compounds, or any combination thereof.

7. The multilayer structure of claim 1, wherein the first and second rigid dielectric composite layers are electrically insulating and have a Young's modulus greater than 10 GPa.

8. A battery comprising:
a plurality of electrochemical cells, each electrochemical cell comprising:
a first electrode,
a second electrode, and
an electrolyte positioned between the first electrode and the second electrode;
a first current collector associated with a first electrochemical cell and a second current collector associated with an adjacent electrochemical cell; and
a multilayer structure, according to claim 1, positioned between the first current collector and the second current collector, the multilayer structure comprising:
a conductive heating layer configured to generate heat through resistive heating; and
first and second rigid dielectric composite layers positioned on opposite sides of the conductive heating layer, the rigid dielectric composite layers being electrically insulating and having a Young's modulus greater than 1 GPa,
wherein the conductive heating layer is electrically isolated from the first and second current collectors and is configured to selectively generate heat.

9. The battery of claim 8, wherein the conductive heating layer comprises a patterned conductive heating layer, the patterned conductive heating layer comprising a non-continuous conductive structure having interruptions that define resistive paths configured to regulate current flow and heat distribution.

10. The battery of claim 8, wherein the multilayer structure is positioned between every 3 to 30 electrochemical cells within the battery stack.

11. The battery of claim 8, wherein the conductive heating layer is configured to be selectively activated based on a control signal from a battery management system.

12. The battery of claim 8, wherein the first and second rigid dielectric composite layers are electrically insulating and have a Young's modulus greater than 10 GPa.

13. A method for manufacturing a multilayer structure, according to claim 1, the method comprising:
forming a first rigid dielectric composite layer and a second rigid dielectric composite layer, each having a Young's modulus greater than 1 GPa;
positioning a conductive heating layer between the first and second rigid dielectric composite layers; and
bonding the first and second rigid dielectric composite layers to the conductive heating layer.

14. The method of claim 13, further comprising patterning the conductive heating layer to define interruptions that regulate current flow and heat distribution.

15. A method for manufacturing a battery comprising the multilayer structure of claim 1, the method comprising:
assembling a battery stack comprising a plurality of electrochemical cells, each electrochemical cell comprising:
a first electrode,
a second electrode, and
an electrolyte positioned between the first electrode and the second electrode;
positioning a first current collector adjacent to a first electrochemical cell and a second current collector adjacent to an adjacent electrochemical cell;
pre-fabricating a multilayer structure comprising:
a conductive heating layer positioned between a first rigid dielectric composite layer and a second rigid dielectric composite layer, wherein the first and second rigid dielectric composite layers are electrically insulating and have a Young's modulus greater than 1 GPa; and
positioning the pre-fabricated multilayer structure between the first and second current collectors.

16. A method for manufacturing a battery comprising a multilayer structure of claim 1, the method comprising:
assembling a battery stack comprising a plurality of electrochemical cells, each electrochemical cell comprising:
a first electrode,
a second electrode, and
an electrolyte positioned between the first electrode and the second electrode;
positioning a first current collector adjacent to a first electrochemical cell and a second current collector adjacent to an adjacent electrochemical cell;
forming a first rigid dielectric composite layer directly on the first current collector and a second rigid dielectric composite layer directly on the second current collector, wherein each of the first and second rigid dielectric composite layers is electrically insulating and has a Young's modulus greater than 1 GPa; and
positioning a conductive heating layer between the first rigid dielectric composite layer and the second rigid dielectric composite layer.

17. A method for heating a multilayer structure of claim 1, the method comprising:
applying an electrical current to a conductive heating layer positioned between a first rigid dielectric composite layer and a second rigid dielectric composite layer, the first and second rigid dielectric composite layers having a Young's modulus greater than 1 GPa; and
generating resistive heat within the conductive heating layer in response to the applied electrical current.

18. A method for heating a battery, the method comprising:
applying an electrical current to a conductive heating layer positioned within a multilayer structure integrated within a battery stack, the multilayer structure further comprising first and second rigid dielectric composite layers on opposite sides of the conductive heating layer;
generating resistive heat within the conductive heating layer in response to the applied electrical current; and
transferring heat from the conductive heating layer to an electrolyte of the battery to improve ionic conductivity.

19. The method of claim 18, wherein the conductive heating layer comprises a patterned conductive heating layer, the patterned conductive heating layer comprising a non-continuous conductive structure having interruptions that define resistive paths configured to regulate current flow and heat distribution.

20. The method of claim 18, wherein the electrical current is applied intermittently or in pulses to maintain the electrolyte within a target temperature range while minimizing power consumption.
